(19) United States
(12) Patent Application Publication
(10) Pub. No.: US 2025/0236336 A1
(43) Pub. Date: Jul. 24, 2025

(54) VEHICLE CONTROL METHOD AND INPUT/OUTPUT CONTROL DEVICE

(71) Applicant: Panasonic Automotive Systems Co., Ltd., Kanagawa (JP)

(72) Inventors: Akihito MURAI, Kanagawa Ken (JP); Hirofumi NISHIMURA, Kanagawa Ken (JP); Yoshimasa OKABE, Kanagawa Ken (JP)

(73) Assignee: Panasonic Automotive Systems Co., Ltd., Kanagawa (JP)

(21) Appl. No.: 19/016,841

(22) Filed: Jan. 10, 2025

(30) Foreign Application Priority Data
Jan. 19, 2024 (JP) 2024-006504

(51) Int. Cl. B62D 15/02; B60K 35/10; B60K 35/22; B60W 30/06

(52) U.S. Cl. CPC B62D 15/0285; B60K 35/10; B60K 35/22; B60W 30/06; B60K 2360/1438

(57) ABSTRACT

A vehicle control method includes: detecting at least a first parking position and a second parking position based on an external situation acquired by a sensor that acquires an external situation of a vehicle; displaying the first parking position and a first recommendation degree of the first parking position and the second parking position and a second recommendation degree of the second parking position by a display device that is installed so as to be visually recognizable by an occupant; and when an input device receives an operation of the occupant selecting one of the first parking position and the second parking position, controlling the at least steering such that the vehicle travels toward a selected one of the first parking position and the second parking position by a vehicle controller.

### CROSS-REFERENCE TO RELATED APPLICATIONS

This application is based upon and claims the benefit of priority from Japanese Patent Application No. 2024-006504, filed on Jan. 19, 2024, the entire contents of which are incorporated herein by reference.

### FIELD

The present disclosure relates to a vehicle control method and an input/output control device.

### BACKGROUND

Conventionally, a parking assistance technique for moving a vehicle by automatic driving when parking the vehicle has been known. As one of such parking assistance techniques, for example, a technique of detecting an available parking frame in a parking lot and automatically parking the vehicle in the parking frame is known.

In addition, there is also proposed a technique of outputting results corresponding to items such as a required time, the number of times turning back for position adjustment is to be performed and the curvature in a route, and steering-in-position when parking the vehicle using a parking assistance technique for the detected parking frame.

A related technique is described in Japanese Patent Laid-open No. 2018-124920

However, in the conventional technique, there is a case where the output result is not suitable for the parking scene, the environment, the driver's request, or the like when automatic parking is actually executed. Therefore, parking assistance is sometimes not used, and there is room for further improvement.

The present disclosure has been made in view of the above problem, and provides a vehicle control method and an input/output control device capable of improving convenience of a driver or a user when performing parking assistance or automatic parking of a vehicle as compared with conventional methods.

### SUMMARY

A vehicle control method according to the present disclosure is a control method of a vehicle including a sensor that acquires an external situation, a display device that is installed so as to be visually recognizable by an occupant, an input device that receives an operation of the occupant, and a vehicle controller that controls at least steering. The vehicle control method includes: detecting at least a first parking position and a second parking position based on the external situation acquired by the sensor; displaying the first parking position and a first recommendation degree of the first parking position and the second parking position and a second recommendation degree of the second parking position by the display device; and when the input device receives an operation of selecting one of the first parking position and the second parking position, controlling the at least steering such that the vehicle travels toward a selected one of the first parking position and the second parking position by the vehicle controller.

### BRIEF DESCRIPTION OF THE DRAWINGS

FIG. 1 is a block diagram illustrating an example of an overall configuration of a vehicle according to an embodiment;

FIG. 2 is a block diagram illustrating an example of a hardware configuration of a vehicle control device according to the embodiment;

FIG. 3 is a diagram for describing an example of vehicle parking assistance according to the embodiment;

FIG. 4 is a diagram for describing an example of a recommendation degree according to the embodiment;

FIG. 5 is a flowchart illustrating an example of processing of the vehicle control device according to the present embodiment;

FIG. 6 is a flowchart illustrating an example of processing of a display device according to the present embodiment;

FIG. 7 is a diagram for describing an example of a recommendation degree according to a first modification;

FIG. 8 is a diagram for describing an example of a recommendation degree according to the first modification;

FIG. 9 is a diagram for describing an example of a recommendation degree according to the first modification;

FIG. 10 is a diagram for describing an example of a recommendation degree according to the first modification;

FIG. 11 is a diagram for describing an example of a recommendation degree according to the first modification;

FIG. 12 is a diagram for describing an example of setting of a weighting factor of a scale according to a second modification;

FIG. 13 is a diagram for describing an example of setting of a weighting factor of a scale according to the second modification;

FIG. 14 is a diagram for describing an example of setting of a weighting factor of a scale according to the second modification;

FIG. 15 is a diagram for describing an example of a recommendation degree according to a third modification;

FIG. 16 is a diagram for describing an example of a recommendation degree according to the third modification; and

FIG. 17 is a diagram for describing an example of a recommendation degree according to the third modification.

### DETAILED DESCRIPTION

Hereinafter, embodiments of a vehicle control method and an input/output control device according to the present disclosure will be described with reference to the drawings.

In the description of the present disclosure, components having the same or substantially the same functions as those described earlier with respect to the previously described drawings are denoted by the same reference numerals, and the description thereof may be appropriately omitted. In addition, even in the case of representing the same or substantially the same portion, the dimensions and ratios may be represented differently depending on the drawings. Furthermore, for example, from the viewpoint of ensuring visibility of the drawings, in the description of each drawing, only main components are denoted by reference numerals, and even components having the same or substantially the same functions as those described earlier in the previous drawings are not denoted by reference numerals in some cases.

One example of a scene in which a vehicle control system including a vehicle control device of the present embodiment is used is when a vehicle is parked in a parking lot at a place outside the house, a parking position where the vehicle can be parked is detected, and the vehicle is automatically parked in the parking position selected by the user. Note that while the present embodiment describes an example in which parking is automatically executed with the user riding the vehicle, the user may perform an operation of a vehicle 1 related to forward/backward movement and acceleration/deceleration and a vehicle control unit (vehicle controller) 11 may control only steering of the vehicle 1.

### Embodiment

An input/output control device according to the present embodiment is a device set to be coupled to a sensor that acquires a situation outside the vehicle, a display device installed so as to be visually recognizable by an occupant of the vehicle, an input device that receives an operation of the occupant, and a vehicle control unit that controls at least steering of the vehicle 1.

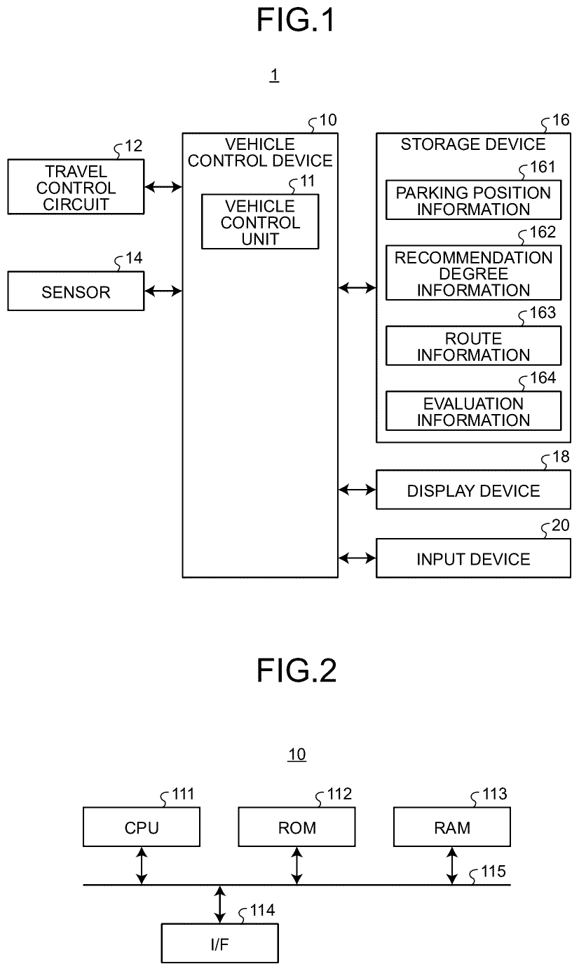

FIG. 1 is a block diagram illustrating an example of an overall configuration of the vehicle 1 according to the embodiment. The vehicle 1 includes a vehicle control device 10, a travel control circuit 12, a sensor 14, a storage device 16, a display device 18, and an input device 20. The vehicle control device 10, the travel control circuit 12, the sensor 14, the storage device 16, the display device 18, and the input device 20 are connected so as to be able to exchange data or signals. That is, the vehicle control device 10 is set to be communicably connected to at least the travel control circuit 12, the sensor 14, the storage device 16, the display device 18, and the input device 20.

The travel control circuit 12 is means for achieving driving, braking, and turning motions necessary for traveling of the vehicle 1. For example, the travel control circuit 12 includes a drive motor, a power transmission mechanism, a brake device, a steering device, and the like, and an electronic vehicle control device that controls those components. The travel control circuit 12 causes the vehicle 1 to travel by, for example, generating power with the drive motor and transmitting the power to wheels via the power transmission mechanism. The power transmission mechanism is, for example, a propeller shaft, a differential gear, a drive shaft, and the like.

The sensor 14 is various sensors that are mounted on the vehicle 1 and detect a traveling state of the vehicle 1. The sensor 14 includes, for example, an accelerator opening sensor that detects an accelerator opening, a steering angle sensor that detects a steering angle of a steering device, an acceleration sensor that detects acceleration acting in the front-rear direction of the vehicle 1, a torque sensor that detects torque acting on the power transmission mechanism between wheels of the vehicle 1 and the drive motor, a vehicle speed sensor that detects a vehicle speed of the vehicle 1, a wheel speed sensor, and the like.

Furthermore, the sensor 14 is various sensors that are mounted on the vehicle 1 and acquire an external situation. The sensor 14 includes, for example, at least one of a camera, an ultrasonic sensor, a radar, and the like. The sensor 14 outputs sensor information obtained by the detection to the vehicle control device 10.

The camera is a surrounding sensor that is mounted on the vehicle 1 and monitors the surrounding environment of the vehicle 1. The camera acquires an external video. In the present embodiment, the camera images the surroundings of the vehicle 1, and sequentially outputs the captured images to the vehicle control device 10. In the present embodiment, the camera outputs, to the vehicle control device 10, a captured video including a plurality of captured images along a time series obtained by imaging the surroundings of the vehicle 1 along the time series. Hereinafter, the captured video may be simply referred to as a video.

Furthermore, in the present embodiment, the camera is also used for detecting an object present around the vehicle 1 and estimating the position of the vehicle 1 from the positional relationship between the vehicle 1 and the object present around the vehicle 1. The position, the number, and the imaging direction of the cameras are adjusted in advance so that the surroundings of the vehicle 1 can be imaged. For example, the vehicle 1 is provided with four cameras arranged so as to be able to capture four directions of the front, the rear, the left, and the right of the vehicle 1. Note that the number of cameras provided in the vehicle 1 is not limited to four.

The ultrasonic sensor transmits sound waves to the outside, and acquires an external situation from the reflected waves. Hereinafter, the ultrasonic sensor may be referred to as sonar. The radar transmits electromagnetic waves to the outside, and acquires an external situation from the reflected waves.

The storage device 16 stores various data. In the present embodiment, the storage device 16 stores data such as parking position information 161, recommendation degree information 162, route information 163, and evaluation information 164. Details of the parking position information 161, the recommendation degree information 162, the route information 163, and the evaluation information 164 will be described later. The storage device 16 is, for example, an auxiliary storage device such as a hard disk drive (HDD), a solid state drive (SSD), or a flash memory.

The parking position information 161 is information including detection of a parking position indicating a parking area existing around the vehicle 1 when an automatic parking function is started. Furthermore, the parking position information 161 may include information obtained by detecting a parking position candidate indicating a vacant parking area of the vehicle 1. Furthermore, the parking position information 161 may include latitude and longitude information at the parking position.

The recommendation degree information 162 is information including a recommendation degree corresponding to a parking position candidate indicating a vacant parking area of the vehicle 1 when the automatic parking function is started. Details will be described later. The route information 163 is information, corresponding to the parking position candidate, including a travel route from the position of the vehicle 1 to the parking position candidate. The travel route is generated by applying a known method. The evaluation information 164 is information including evaluation items for obtaining the recommendation degree. Details will be described later.

The display device 18 is a display that displays various images. The display device 18 is installed so as to be visually recognizable by the user who is an occupant of the vehicle 1. Examples of the display include a liquid crystal display (LCD), an organic electro-luminescence (EL) display, and a projector. The display is an example of a display unit.

The input device 20 acquires a user's input operation. The input device 20 is, for example, a device that receives an operation of an occupant. The input device 20 is, for example, an input device such as a keyboard, a touch panel, or a switch. The input device 20 may be a touch panel display integrally configured with the display device 18. That is, the input device 20 may be a touch panel superimposed on the display unit of the display device 18.

The vehicle control device 10 is an electronic control unit that integrally controls the units of the vehicle 1. The vehicle control device 10 controls the travel control circuit 12 so that the traveling state of the vehicle 1 is optimized using sensor information and the like received from the sensor 14. In addition, the vehicle control device 10 controls the travel control circuit 12 to cause the vehicle 1 to travel autonomously. The vehicle control device 10 is an example of the input/output control device.

Here, a hardware configuration of the vehicle control device 10 will be described. FIG. 2 is a block diagram illustrating an example of a hardware configuration of the vehicle control device 10 according to the embodiment. The vehicle control device 10 has a hardware configuration using a normal computer in which a central processing unit (CPU) 111, a read only memory (ROM) 112, a random access memory (RAM) 113, an I/F 114 for connecting to various devices, and the like are connected to each other via a bus 115.

The CPU 111 is an arithmetic device that controls overall processing of the vehicle control device 10. The ROM 112 stores programs and the like for achieving various processing by the CPU 111. The RAM 113 stores data necessary for various processing by the CPU 111. The I/F 114 is an interface that is connected to an external device or an external terminal via a communication line or the like and transmits and receives data to and from the connected external device or external terminal.

A program for executing the above-described various processing executed by the vehicle control device 10 is provided by being incorporated in the ROM 112 or the like in advance. The program for executing a vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

The hardware configurations of the display device 18 and the input device 20 are also similar to the hardware configuration of the vehicle control device 10 illustrated in FIG. 2, and thus, detailed description thereof is omitted.

Returning to FIG. 1, the vehicle control device 10 includes the vehicle control unit 11. A part or all of the vehicle control unit 11 may have a software configuration implemented by cooperation of a processor and various programs stored in a memory. In addition, a part or all of the vehicle control unit 11 may have a hardware configuration implemented by a dedicated circuit or the like.

The vehicle control unit 11 integrally controls processing related to each function of the vehicle.

In the present embodiment, the vehicle control unit 11 controls at least steering of the vehicle 1 on the basis of an input operation or the like of the input device 20 by the user.

Specifically, when the user performs an input operation of the input device 20 corresponding to an automatic parking start function, the vehicle control unit 11 starts the automatic parking function. In addition, the vehicle control unit 11 starts detection of a parking position indicating a parking area existing around the vehicle 1. Furthermore, the vehicle control unit 11 detects parking position candidates indicating vacant parking areas of the vehicle 1, and outputs the parking position candidates to the display device 18.

Then, the vehicle control unit 11 receives a parking position candidate selected by the user via the input device 20 from among the parking position candidates. In addition, the vehicle control unit 11 generates a travel route corresponding to the selected parking position candidate. Furthermore, the vehicle control unit 11 controls at least steering of the vehicle 1 in order to perform automatic parking travel on the basis of the generated travel route.

In addition, the vehicle control unit 11 normally controls forward/backward movement and acceleration/deceleration in addition to steering, but the user may perform an operation of the vehicle 1 related to forward/backward movement and acceleration/deceleration while the vehicle control unit 11 controls only steering of the vehicle 1.

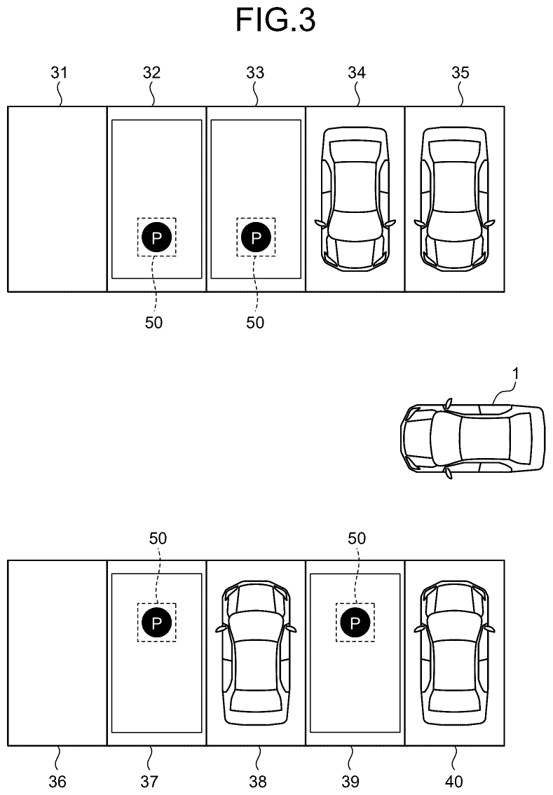

Next, an example of a parking scene according to the present embodiment will be described with reference to FIG. 3. FIG. 3 is a diagram for describing an example of vehicle parking assistance according to the embodiment. FIG. 3 illustrates the vehicle 1, parking positions 31 to 40 indicating a parking area of the vehicle 1, and parking position candidates 50 indicating vacant parking areas of the vehicle 1. In FIG. 3, other vehicles are already parked at parking positions 34, 35, 38, and 40. In addition, the vehicle control device 10 detects the parking positions 32, 33, 37, and 39 as the parking position candidates 50.

For example, in the parking scene illustrated in FIG. 3, the input/output control device according to the present embodiment detects at least a first parking position and a second parking position on the basis of an external situation acquired by the sensor 14, causes the display device 18 to display the first parking position and a first recommendation degree of the first parking position and the second parking position and a second recommendation degree of the second parking position, and when the input device 20 receives an operation of selecting one of the first parking position and the second parking position, the vehicle control unit 11 controls at least steering such that the vehicle 1 travels toward the selected one of the first parking position and the second parking position.

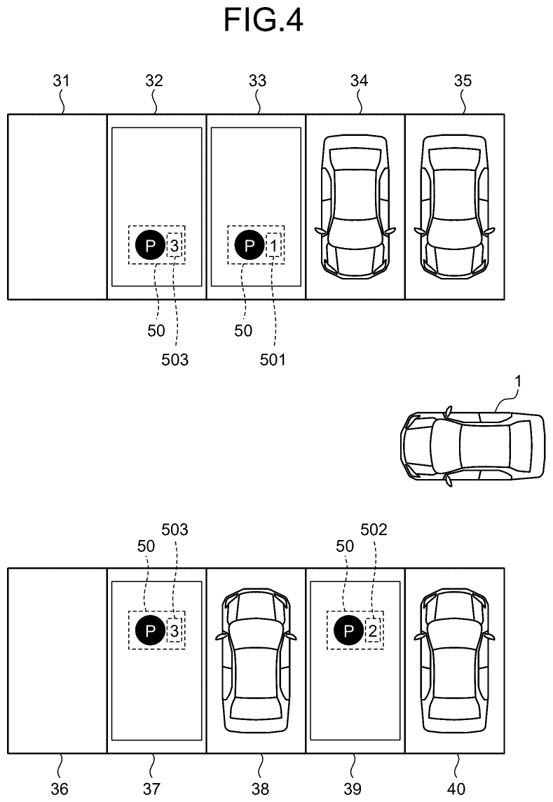

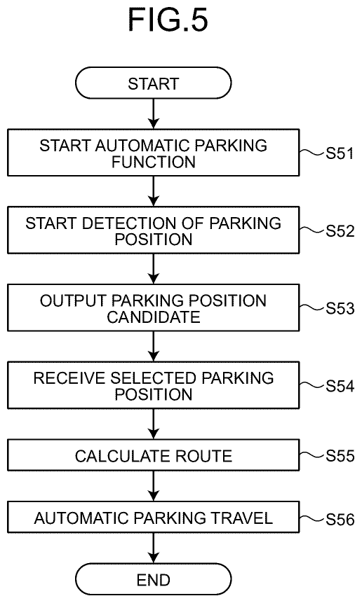

Here, the first recommendation degree of the first parking position and the second parking position and the second recommendation degree of the second parking position will be described with reference to FIG. 4. FIG. 4 is a diagram for describing an example of the recommendation degree according to the embodiment. In FIG. 4, in addition to the content described in FIG. 3, recommendation degrees 501 to 503 are further given to the parking position candidates 50.

The recommendation degree 501 corresponds to the parking position candidate 50 of the parking position 33. Furthermore, the recommendation degree 502 corresponds to the parking position candidate 50 of the parking position 39. Furthermore, the recommendation degree 503 corresponds to the parking position candidates 50 of the parking position 33 and the parking position 37. In addition, regarding the level of recommendation indicated by the recommendation degree illustrated in FIG. 4, the recommendation degree 501 is the highest, and subsequently, the recommendation degree 502 and the recommendation degree 503 are indicated in the order of recommendation.

Note that in order to describe the recommendation degree more specifically, in FIG. 4, assume that the first parking position is the parking position 33 and the second parking position is the parking position 39. Furthermore, in FIG. 4, assume that the first recommendation degree is the recommendation degree 501 of the parking position 33 and the second recommendation degree is the recommendation degree 502 of the parking position 39.

First, in order to obtain (generate) the recommendation degrees corresponding to the parking position candidates, the display device 18 obtains the recommendation degree 501 and the recommendation degree 502 on the basis of the positional relationship between the position of the vehicle 1 and the parking position 33 and the parking position 39 at a time point before displaying the parking position 33 and the recommendation degree 501 of the parking position 33 and the parking position 39 and the recommendation degree 502 of the parking position 39.

For example, the display device 18 obtains a first route from the position of the vehicle 1 to the parking position 33 at a time point before the parking position 33 and the recommendation degree 501 of the parking position 33 are displayed, and a second route from the position of the vehicle 1 to the parking position 39 at a time point before the parking position 39 and the recommendation degree 502 of the parking position 39 are displayed, and obtains the recommendation degree 501 and the recommendation degree 502 on the basis of the first route and the second route.

Then, the display device 18 displays the parking position 33 and the recommendation degree 501, and the parking position 39 and the recommendation degree 502, and also displays the first route and the second route.

The recommendation degree is information based on an evaluation value of one or more evaluation items regarding parking assistance when the display device 18 displays a parking position candidate. The evaluation items include, for example, a plurality of evaluation items such as the number of times turning back for position adjustment is to be performed in the travel route, the shortest distance to an obstacle in the travel route, the maximum steering angle, the number of times stationary steering is to be performed, the required time of the travel route, the area required for the travel route, the performance at the parking position related to the travel route, the level of closeness to the adjacent vehicle at the parking position, and the presence or absence of a roof at the parking position. For each of the plurality of evaluation items, a weighting factor corresponding to the priority regarding parking is set. That is, the recommendation degree is information including a multiplication value obtained by multiplying the evaluation value (hereinafter also referred to as scale) of each evaluation item by a weighting factor. The display device 18 obtains the recommendation degree by multiplying the weighting factor of the scale and adding the result to the evaluation value of the parking position candidate.

For example, the recommendation degree 501 of the parking position 33 is higher than the recommendation degree 502 of the parking position 39 when at least one of the following conditions are satisfied: in FIG. 4, if the recommendation degree 501 is higher than the recommendation degree 502, a first number of times turning back for position adjustment is to be performed in the first route is smaller than a second number of times turning back for position adjustment is to be performed in the second route, a first shortest distance to the peripheral obstacle in the first route is larger than a second shortest distance to the peripheral obstacle in the second route, a first maximum steering angle in the first route is smaller than a second maximum steering angle in the second route, a first maximum angular velocity of the steering angle in the first route is smaller than a second maximum velocity of the steering angle in the second route, a first number of times stationary steering is to be performed in the first route is smaller than a second number of times stationary steering is to be performed in the second route, a first required time of the first route is shorter than a second required time of the second route, a first area required for the first route is smaller than a second area of the second route, and a first performance of parking at the first parking position related to the first route is higher than a second performance of parking at the second parking position related to the second route.

Furthermore, for example, the recommendation degree 501 of the parking position 33 is higher than the recommendation degree 502 of the parking position 39 when at least one of the following conditions are satisfied: in FIG. 4, if the recommendation degree 501 is higher than the recommendation degree 502, a first distance from the adjacent vehicle at the parking position 33 is larger than a second distance from the adjacent vehicle at the parking position 39, and a first coverage of a roof at the parking position 33 is larger than a second coverage of a roof at the parking position 39. Here, the coverage of the roof is a ratio at which the roof occupies the space above the vehicle 1 at the end of parking.

As a result, the input/output control device can improve convenience of the driver or the user when performing parking assistance or automatic parking of the vehicle as compared with conventional methods.

FIG. 5 is a flowchart illustrating an example of processing of the vehicle control device 10 according to the present embodiment.

In step S51, when the user performs an input operation of the input device 20 corresponding to the automatic parking start function, the vehicle control unit 11 starts the automatic parking function (Step S51). In step S52, the vehicle control unit 11 starts detection of a parking position indicating a parking area existing around the vehicle 1 (Step S52).

In step S53, the vehicle control unit 11 detects parking position candidates indicating vacant parking areas of the vehicle 1, and outputs the parking position candidates to the display device 18 (Step S53). In step S54, the vehicle control unit 11 receives a parking position candidate selected by the user via the input device 20 from among the parking position candidates (Step S54).

In step S55, the vehicle control unit 11 generates a travel route corresponding to the selected parking position candidate (Step S55). In step S56, the vehicle control unit 11 controls at least steering of the vehicle 1 in order to perform automatic parking travel on the basis of the generated travel route (Step S56). When the processing of step S56 ends, the vehicle control device 10 ends this processing.

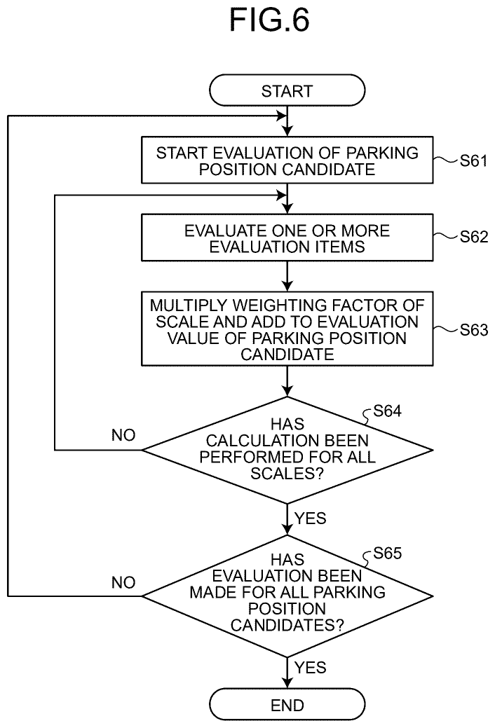

FIG. 6 is a flowchart illustrating an example of processing of the display device 18 according to the present embodiment. Note that the processing illustrated in FIG. 6 is performed after step S53 illustrated in FIG. 5 described above. That is, in the processing illustrated in FIG. 6, processing in which the display device 18 obtains a recommendation degree corresponding to the parking position candidate and displays the recommendation degree for each parking position candidate will be described.

In step S61, the display device 18 starts evaluation regarding parking assistance for the parking position candidate output by the vehicle control device 10 (Step S61). In step S62, the display device 18 evaluates one or more evaluation items regarding parking assistance on the basis of the positional relationship between the position of the vehicle 1 and the parking position candidate (Step S62).

In step S63, the display device 18 multiplies the evaluation value of each evaluation item by a weighting factor, adds the evaluation value to the evaluation value of the parking position candidate, and obtains the recommendation degree (Step S63). In step S64, the display device 18 determines whether calculation has been performed for all the scales (Step S64). Here, when determining that the calculation has not been performed for all the scales (Step S64: No), the display device 18 proceeds to step S62. On the other hand, when determining that the calculation has been performed for all the scales (Step S64: Yes), the display device 18 proceeds to step S65.

In step S65, the display device 18 determines whether all the parking position candidates have been evaluated (Step S65). Here, when determining that not all the parking position candidates have been evaluated (Step S65: No), the display device 18 proceeds to step S61. On the other hand, when the display device 18 determines that all the parking position candidates have been evaluated (Step S65: Yes), the display device 18 displays the recommendation degree for each parking position candidate and displays the travel route for each parking position candidate.

As described above, the vehicle control method according to the present embodiment is a control method of a vehicle including the sensor 14 that acquires an external situation, the display device 18 that is installed so as to be visually recognizable by an occupant, the input device 20 that receives an operation of the occupant, and the vehicle control unit 11 that controls at least steering, the vehicle control method including: detecting at least the first parking position and the second parking position on the basis of the external situation acquired by the sensor 14; displaying the first parking position and the first recommendation degree of the first parking position and the second parking position and the second recommendation degree of the second parking position by the display device 18; and when the input device 20 receives an operation of selecting one of the first parking position and the second parking position, controlling at least steering such that the vehicle 1 travels toward the selected one of the first parking position and the second parking position by the vehicle control unit 11.

As a result, the driver or the user riding the vehicle 1 can confirm the recommendation degree for each parking position candidate output by the display device 18 and move the vehicle 1 to the parking position selected by the driver or the user.

Therefore, according to the control method of the vehicle 1 according to the present disclosure, convenience of the driver or the user can be improved as compared with conventional methods.

### First Modification

In the embodiment described above, regarding the recommendation degree, the parking position candidates are displayed in the order of recommendation (numbers, see FIG. 4), but the recommendation degree is not limited thereto. For example, the recommendation degree may indicate the order of recommendation by color, size, color density, hatching, the performance of parking at a parking position, or the like.

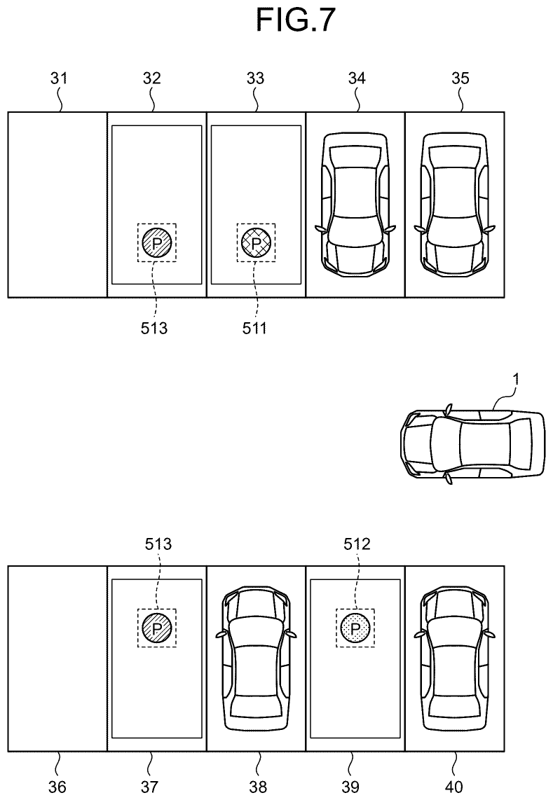

FIGS. 7 to 11 are diagrams for describing examples of the recommendation degree according to a first modification. FIGS. 7 to 11 are modifications of the recommendation degree illustrated in FIG. 4.

For example, a recommendation degree 511 illustrated in FIG. 7 corresponds to the recommendation degree 501 illustrated in FIG. 4. Additionally, a recommendation degree 512 illustrated in FIG. 7 corresponds to the recommendation degree 502 illustrated in FIG. 4. Furthermore, a recommendation degree 513 illustrated in FIG. 7 corresponds to the recommendation degree 503 illustrated in FIG. 4. For example, in the first modification, in FIG. 7, the recommendation degree 511 is indicated by red, the recommendation degree 512 is indicated by yellow, and the recommendation degree 513 is indicated by blue.

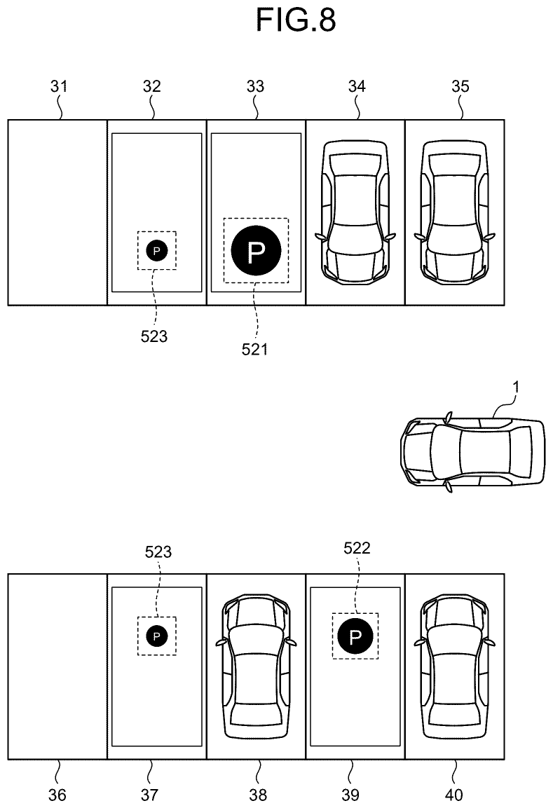

For example, a recommendation degree 521 illustrated in FIG. 8 corresponds to the recommendation degree 501 illustrated in FIG. 4. Additionally, a recommendation degree 522 illustrated in FIG. 8 corresponds to the recommendation degree 502 illustrated in FIG. 4. Furthermore, a recommendation degree 523 illustrated in FIG. 8 corresponds to the recommendation degree 503 illustrated in FIG. 4. For example, in the first modification, the recommendation degrees are indicated to be smaller in the order of 521, 522, and 523 in FIG. 8.

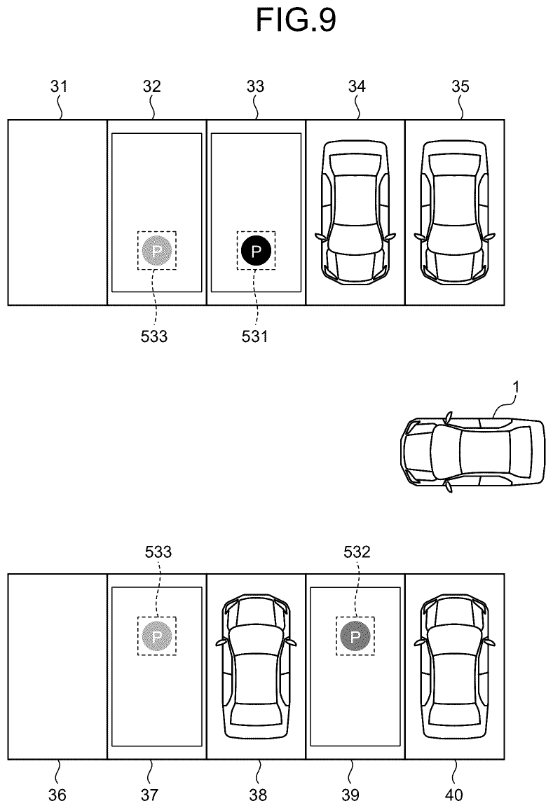

For example, a recommendation degree 531 illustrated in FIG. 9 corresponds to the recommendation degree 501 illustrated in FIG. 4. Additionally, a recommendation degree 532 illustrated in FIG. 9 corresponds to the recommendation degree 502 illustrated in FIG. 4. Furthermore, a recommendation degree 533 illustrated in FIG. 9 corresponds to the recommendation degree 503 illustrated in FIG. 4. For example, in the first modification, the color density is illustrated to be lower in the order of the recommendation degrees 531, 532, and 533 in FIG. 9.

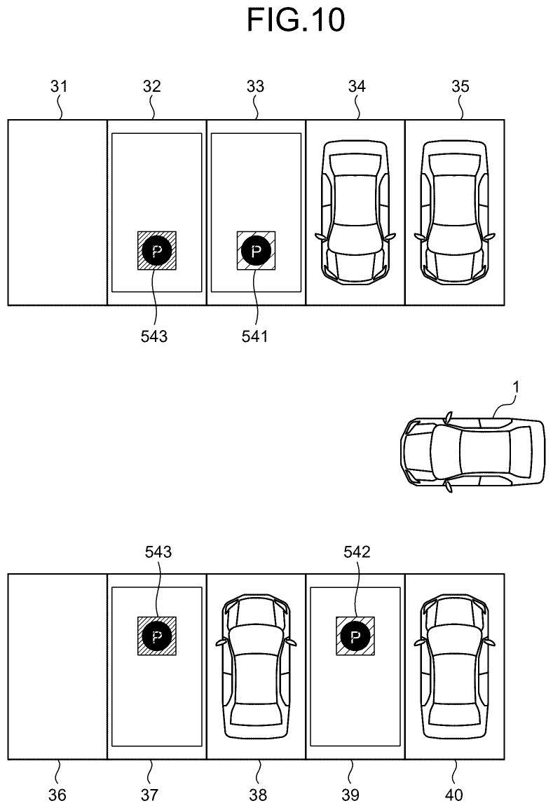

For example, a recommendation degree 541 illustrated in FIG. 10 corresponds to the recommendation degree 501 illustrated in FIG. 4. Additionally, a recommendation degree 542 illustrated in FIG. 10 corresponds to the recommendation degree 502 illustrated in FIG. 4. Furthermore, a recommendation degree 543 illustrated in FIG. 10 corresponds to the recommendation degree 503 illustrated in FIG. 4. For example, in the first modification, the fineness of hatching is illustrated to be reduced in the order of the recommendation degrees 541, 542, and 543 in FIG. 10.

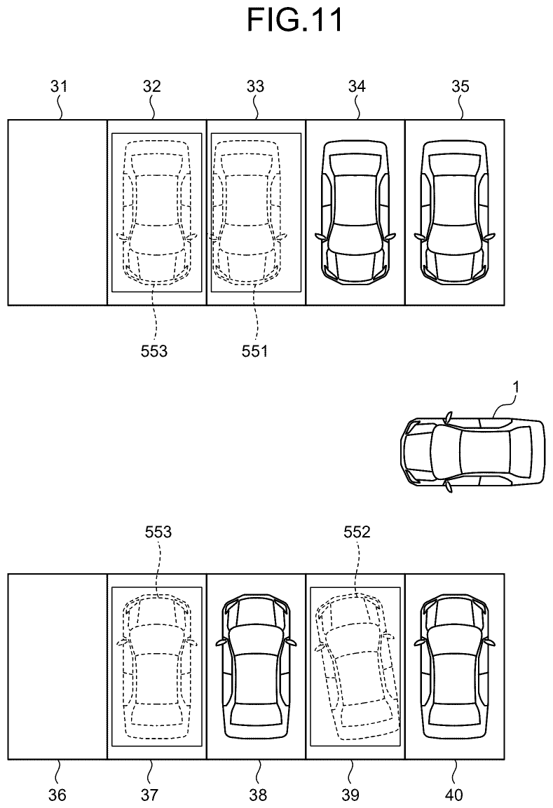

For example, a recommendation degree 551 illustrated in FIG. 11 corresponds to the recommendation degree 501 illustrated in FIG. 4. Additionally, a recommendation degree 552 illustrated in FIG. 11 corresponds to the recommendation degree 502 illustrated in FIG. 4. Furthermore, a recommendation degree 553 illustrated in FIG. 11 corresponds to the recommendation degree 503 illustrated in FIG. 4. For example, in the first modification, the recommendation degrees 541, 542, and 543 in FIG. 11 are illustrated with respect to the performance of parking at the parking position.

### Second Modification

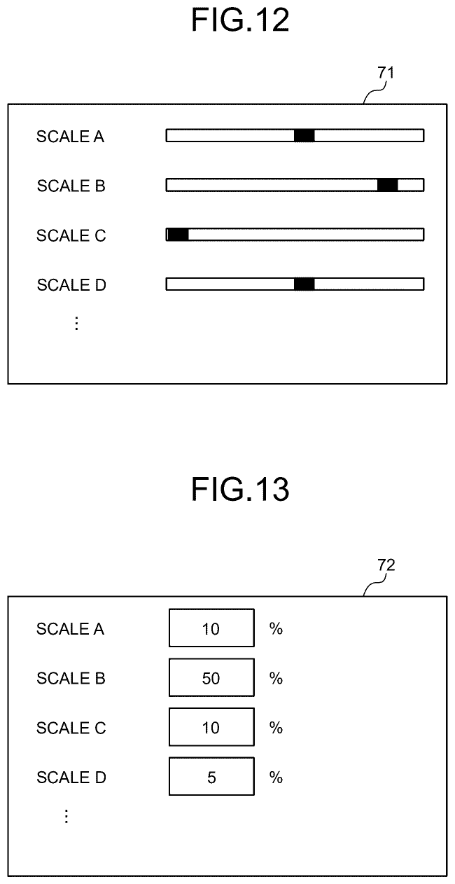

In a control method of a vehicle 1 according to a second modification, the setting regarding how to obtain the first recommendation degree of the first parking position and the second recommendation degree of the second parking position may be changeable. For example, weighting may be set for the evaluation value (scale) of each evaluation item according to the preference of the user. FIGS. 12 to 14 are a diagrams for describing examples of setting of a weighting factor of a scale according to a second modification. For example, FIGS. 12 to 14 illustrate screens for changing the weighting of the evaluation value (scale) of each evaluation item, and are output to the display device 18.

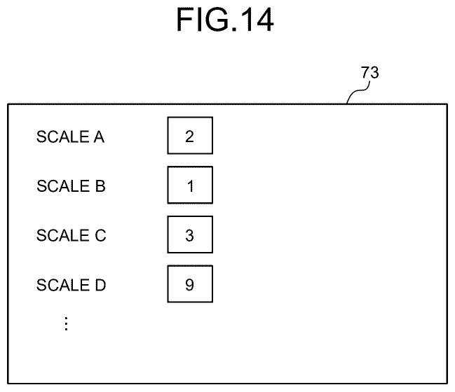

FIG. 12 is a screen on which the user uses a slide bar when setting the weighting of the scale. FIG. 13 is a screen on which the user inputs and sets a ratio when setting the weighting of the scale. FIG. 14 is a screen on which the user inputs and sets a priority order when setting the weighting of the scale. The user can execute parking assistance according to the preference of the user by setting the weighting of the scale, so that convenience of the driver or the user can be improved as compared with conventional methods.

### Third Modification

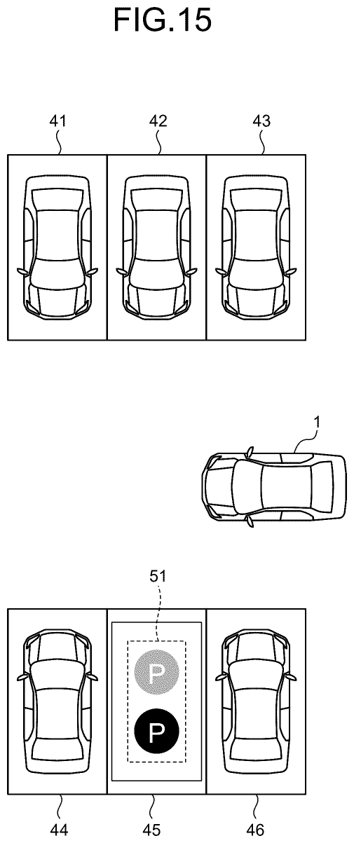

While the above embodiments describe cases where there is a plurality of parking position candidates as the parking scene, a second modification describes a case where there is one parking position candidate. FIGS. 15 to 17 are diagrams for describing examples of the recommendation degree according to a third modification. FIGS. 15 to 17 illustrate a vehicle 1 and parking positions 41 to 46 indicating parking areas of the vehicle 1.

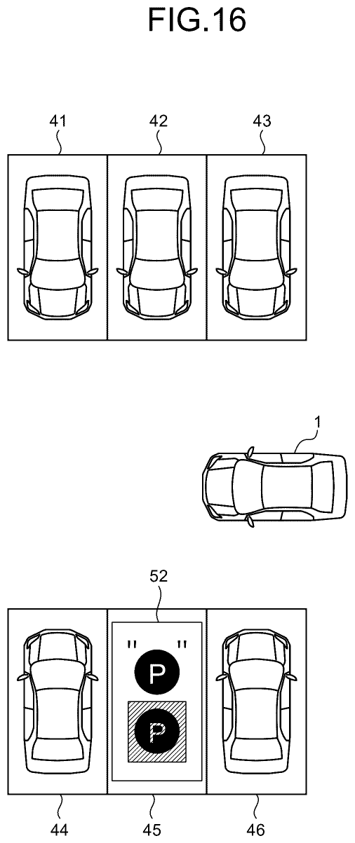

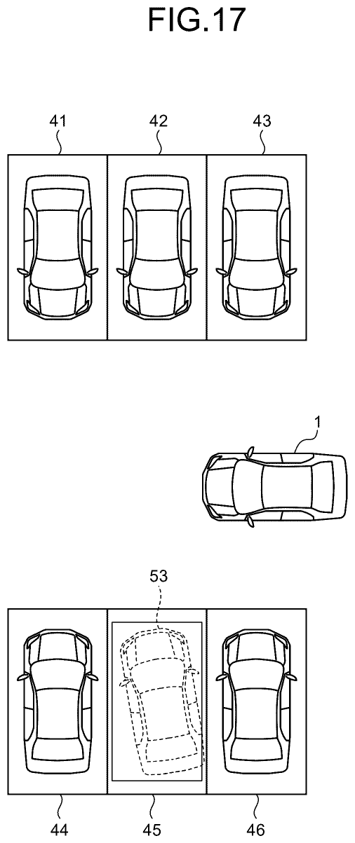

In FIGS. 15 to 17, another vehicle is already parked at the parking positions 41 to 44 and 46. In addition, a vehicle control device 10 detects the parking position 45 as a parking position candidate. FIG. 15 illustrates a recommendation degree 51 of a parking position candidate. FIG. 16 illustrates a recommendation degree 52 of a parking position candidate. FIG. 17 illustrates a recommendation degree 53 of a parking position candidate.

A control method of the vehicle 1 according to the third modification includes: detecting the parking position 45 on the basis of the external situation acquired by a sensor 14; displaying the parking position 45 and the recommendation degrees 51 to 53 of the parking position 45 by a display device 18; and when an input device 20 receives an operation of selecting the parking position 45, controlling at least steering such that the vehicle 1 travels toward the selected parking position 45 by a vehicle control unit 11.

In FIG. 15, the recommendation degree 51 is indicated using color density. For example, in the recommendation degree 51, the higher the color density, the higher the recommendation degree. In FIG. 16, the recommendation degree 52 is indicated by blinking or hatching. For example, in the recommendation degree 512, the lower the blinking speed, the higher the recommendation degree. For example, in the recommendation degree 512, the recommendation degree increases as the fineness of hatching decreases. In FIG. 17, the recommendation degree 53 is indicated using the performance of parking at the parking position.

As a result, the driver or the user riding the vehicle 1 can confirm the recommendation degree for each parking position candidate output by the display device 18 and move the vehicle 1 to the parking position selected by the driver or the user. Therefore, according to the control method of the vehicle 1 according to the third modification, convenience of the driver or the user can be improved as compared with conventional methods.

A program for executing the vehicle control method executed in the present embodiment may be stored on a computer connected to a network such as the Internet and provided by being downloaded via the network. In addition, the program for executing the vehicle control method executed in the present embodiment may be provided or distributed via a network such as the Internet.

According to the vehicle control method of the present disclosure, convenience of a driver or a user can be improved as compared with conventional methods.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method of a vehicle including a sensor that acquires an external situation, a display device that is installed so as to be visually recognizable by an occupant, an input device that receives an operation of the occupant, and a vehicle controller that controls at least steering, the vehicle control method comprising:
detecting at least a first parking position and a second parking position based on the external situation acquired by the sensor;
displaying the first parking position and a first recommendation degree of the first parking position and the second parking position and a second recommendation degree of the second parking position by the display device; and
when the input device receives an operation of selecting one of the first parking position and the second parking position, controlling the at least steering such that the vehicle travels toward a selected one of the first parking position and the second parking position by the vehicle controller.

2. The vehicle control method according to claim 1 further comprising
obtaining the first recommendation degree and the second recommendation degree based on a positional relationship between a position of the vehicle and the first parking position and the second parking position at a time point before the display device displays the first parking position and the first recommendation degree, and the second parking position and the second recommendation degree.

3. The vehicle control method according to claim 2 further comprising
obtaining a first route from the position of the vehicle at the time point to the first parking position and a second route from the position of the vehicle at the time point to the second parking position, and
obtaining the first recommendation degree and the second recommendation degree based on the first route and the second route.

4. The vehicle control method according to claim 3 further comprising
displaying the first parking position and the first recommendation degree, and the second parking position and the second recommendation degree, and also displaying the first route and the second route by the display device.

5. The vehicle control method according to claim 3, wherein the first recommendation degree of the first parking position is higher than the second recommendation degree of the second parking position when at least one of the following conditions are satisfied:
a first number of times turning back for position adjustment is to be performed in the first route is smaller than a second number of times turning back for position adjustment is to be performed in the second route;
a first shortest distance to a peripheral obstacle in the first route is larger than a second shortest distance to a peripheral obstacle in the second route;
a first maximum steering angle in the first route is smaller than a second maximum steering angle in the second route;
a first maximum angular velocity of a steering angle in the first route is smaller than a second maximum velocity of a steering angle in the second route;
a first number of times stationary steering is to be performed in the first route is smaller than a second number of times stationary steering is to be performed in the second route;
a first required time of the first route is shorter than a second required time of the second route;
a first area required for the first route is smaller than a second area of the second route; and
a first performance of parking at the first parking position related to the first route is higher than a second performance of parking at the second parking position related to the second route.

6. The vehicle control method according to claim 1, wherein
a setting regarding how to obtain the first recommendation degree of the first parking position and the second recommendation degree of the second parking position is changeable.

7. The vehicle control method according to claim 1, wherein the sensor that acquires the external situation is at least one of:
a camera that acquires an external video;
a sonar that transmits a sound wave externally and acquires an external situation from a reflected wave thereof, and
a radar that transmits an electromagnetic wave externally and acquires an external situation from a reflected waves thereof.

8. The vehicle control method according to claim 1, wherein the input device is a touch panel superimposed on a display of the display device.

9. The vehicle control method according to claim 1, wherein the first recommendation degree of the first parking position is larger than the second recommendation degree of the second parking position when at least one of the following conditions are satisfied:
a first distance from an adjacent vehicle at the first parking position is larger than a second distance from an adjacent vehicle at the second parking position, and
a first coverage of a roof at the first parking position is larger than a second coverage of a roof at the second parking position.

10. A vehicle control method of a vehicle including a sensor that acquires an external situation, a display device that is installed so as to be visually recognizable by an occupant, an input device that receives an operation of the occupant, and a vehicle controller that controls at least steering, the vehicle control method comprising:
detecting a parking position based on the external situation acquired by the sensor;
displaying the parking position and a recommendation degree of the parking position by the display device; and
when the input device receives an operation of selecting the parking position, controlling the at least steering such that the vehicle travels toward the selected parking position by the vehicle controller.

11. An input/output control device set to be coupled to a sensor that acquires a situation outside a vehicle, a display device that is installed so as to be visually recognizable by an occupant of the vehicle, an input device that receives an operation of the occupant, and a vehicle controller that controls at least steering of the vehicle, the input/output control device:
detects at least a first parking position and a second parking position based on the external situation acquired by the sensor;
causes the display device to display the first parking position and a first recommendation degree of the first parking position and the second parking position and a second recommendation degree of the second parking position; and
when the input device receives an operation of selecting one of the first parking position and the second parking position, causes the vehicle controller to control the at least steering such that the vehicle travels toward a selected one of the first parking position and the second parking position.

12. The input/output control device according to claim 11, wherein
the input/output control device obtains the first recommendation degree and the second recommendation degree based on a positional relationship between a position of the vehicle and the first parking position and the second parking position at a time point before the display device displays the first parking position and the first recommendation degree, and the second parking position and the second recommendation degree.

13. The input/output control device according to claim 12, wherein the input/output control device:
obtains a first route from the position of the vehicle at the time point to the first parking position and a second route from the position of the vehicle at the time point to the second parking position; and
obtains the first recommendation degree and the second recommendation degree based on the first route and the second route.

14. The input/output control device according to claim 13, wherein
the input/output control device causes the display device to display the first parking position and the first recommendation degree, and the second parking position and the second recommendation degree, and also display the first route and the second route.

15. The input/output control device according to claim 13, wherein the first recommendation degree of the first parking position is higher than the second recommendation degree of the second parking position when at least one of the following conditions are satisfied:
a first number of times turning back for position adjustment is to be performed in the first route is smaller than a second number of times turning back for position adjustment is to be performed in the second route;
a first shortest distance to a peripheral obstacle in the first route is larger than a second shortest distance to a peripheral obstacle in the second route;
a first maximum steering angle in the first route is smaller than a second maximum steering angle in the second route;
a first maximum angular velocity of a steering angle in the first route is smaller than a second maximum velocity of a steering angle in the second route;
a first number of times stationary steering is to be performed in the first route is smaller than a second number of times stationary steering is to be performed in the second route;
a first required time of the first route is shorter than a second required time of the second route;
a first area required for the first route is smaller than a second area of the second route; and
a first performance of parking at the first parking position related to the first route is higher than a second performance of parking at the second parking position related to the second route.

16. The input/output control device according to claim 11, wherein
a setting regarding how to obtain the first recommendation degree of the first parking position and the second recommendation degree of the second parking position is changeable.

17. The input/output control device according to claim 11, wherein the sensor that acquires the external situation is at least one of:
a camera that acquires an external video;
a sonar that transmits a sound wave externally and acquires an external situation from a reflected wave thereof, and
a radar that transmits an electromagnetic wave externally and acquires an external situation from a reflected waves thereof.

18. The input/output control device according to claim 11, wherein
the input device is a touch panel superimposed on a display of the display device.

19. The input/output control device according to claim 11, wherein the first recommendation degree of the first parking position is larger than the second recommendation degree of the second parking position when at least one of the following conditions are satisfied:
a first distance from an adjacent vehicle at the first parking position is larger than a second distance from an adjacent vehicle at the second parking position, and
a first coverage of a roof at the first parking position is larger than a second coverage of a roof at the second parking position.
